(19) United States
(12) Patent Application Publication
(10) Pub. No.: US 2015/0289601 A1
(43) Pub. Date: Oct. 15, 2015

(54) Buckle Access Regulating Device

(71) Applicant: Patrick Crossland, Pittsburg, KS (US)

(72) Inventor: Patrick Crossland, Pittsburg, KS (US)

(21) Appl. No.: 14/252,991

(22) Filed: Apr. 15, 2014

Related U.S. Application Data
(63) Continuation-in-part of application No. 14/252,940, filed on Apr. 15, 2014.

(51) Int. Cl. A44B 11/25; E05B 37/00; E05B 65/00; A44B 11/26; A44B 11/00

(52) U.S. Cl. CPC A44B 11/2573; A44B 11/2576; A44B 11/266; A44B 11/006; E05B 65/00; E05B 37/00

(57) ABSTRACT

An access regulating device includes a casing having pivotally coupled lower and upper portions selectively movable between open and closed configurations. A combination lock assembly includes a first portion mounted to the lower portion of the casing and a second portion mounted to the upper portion of the casing. The first and second portions of the combination lock assembly are situated in linear alignment when the upper portion of the casing is at the closed configuration.

### CROSS REFERENCE TO RELATED APPLICATION

This patent application is a Continuation-in-Part of and claims the priority of now-pending U.S. Non-provisional Patent Application No. 14/252,940, filed on Apr. 15, 2014 titled “Buckle Access Regulating Device” which is incorporated by reference in its entirety herein.

### BACKGROUND OF THE INVENTION

This invention relates generally to buckle and fastening devices and, more particularly, to a buckle access regulating device that prevents access to a strap buckle fastening device by toddlers unless assisted by an adult.

Life jackets typically include straps having buckles that are easily fastened to secure the life jacket to a person. Specifically, it is well known that young children in particular should always wear a life jacket or other life preserving product when swimming or boating in a body of water such as a swimming pool, lake, or the like. Young children, however, are notoriously curious and sometimes disengage the quick-connect buckles traditionally used to connect the straps of a life jacket. The buckles most often employed for use with life jackets include a male retainer having a buckle connected to an end of a first strap and a female retainer having a buckle connected to an end of a second strap. The male retainer includes outwardly biased retaining members that are selectively received in complementary slots defined by the female retaining member. The male retaining members may be released from the female retaining member by squeezing respective ends of the male retaining members.

The simplicity of the traditional quick release is worrisome in that a curious child may release the buckle of a life jacket and, potentially, result in harm to the child or even death. Preventing a child from disengaging the retaining members of the male retainer member is of great importance.

Therefore, it would be desirable to have an access regulating apparatus regulates access to a traditional strap buckle type fastening device so as to make it difficult or impossible for a toddler to disengage the male/female fastening device without adult assistance. Further, it would be desirable to have an access regulating apparatus that includes a combination lock assembly or a slider assembly that must be operated before the buckle can be disengaged.

### SUMMARY OF THE INVENTION

An access regulating device for use with a strap buckle device includes a body member defining open front and rear ends and interior space configured to receive retaining prongs of the buckle device. A pair of depressible hook-shaped retainer members is configured to selectively engage the interior area of the female retainer portion of the fastening device. A slider assembly includes an upper portion slidably mounted to the body member and a pair of spaced apart locking members operatively coupled to the upper portion and extending away from the body member through the open front end.

The slider assembly is movable between an extended configuration at which the pair of locking members are adjacent the retainer members, respectively, so as to prevent depression thereof and a retracted configuration at which the pair of locking members are displaced from the retainer members, respectively, so as to allow depression thereof. A stop is coupled to the body member adjacent the open rear end thereof and movable between a locked configuration preventing movement of the slider assembly to the retracted configuration and a released configuration allowing movement of the slider assembly to the retracted configuration.

In another embodiment, the access regulating device includes a casing having pivotally coupled lower and upper portions selectively movable between open and closed configurations. A combination lock assembly includes a first portion mounted to the lower portion of the casing and an second portion mounted to the upper portion of the casing, The first and second portions of the combination lock assembly situated in linear alignment when the upper portion of the casing is at the closed configuration.

The first portion includes a shaft that is selectively movable between a retracted configuration substantially inside the first portion and an extended configuration extending away from the first portion. The second portion includes a plurality of numbered wheels situated adjacent one another and defining a lock passage configured to allow movement of the shaft when respective numbered wheels are configured at a predetermined unlocking configuration and configured to prevent movement of the shaft when the respective numbered wheels are configured at a locking configuration.

Another embodiment discloses a combination lock fastening device that includes a male retaining member having a strap retaining buckle and a pair of selectively depressible retaining members coupled to an inward end of the retaining buckle and extending inwardly. The male retaining member includes a lock shaft coupled to the inward end of the retaining buckle intermediate the pair of retaining members and extending inwardly from the inward end. The lock fastening device includes a female retaining member having a housing having a strap retaining buckle and that defines an interior space and that defines a pair of opposed retaining slots configured to selectively engage the pair of retaining members, respectively, the pair of retaining members being depressible so as to disengage the retaining slots. A plurality of numbered wheels are rotatably mounted in the housing of the female retaining member situated adjacent one another and defining a lock passage configured to receive or release the shaft when respective numbered wheels are configured at a predetermined unlocking configuration and configured to prevent movement of the shaft when the respective numbered wheels are configured at a locking configuration.

Therefore, a general object of this invention is to provide an access regulating apparatus that controls access to a male/female fastening device such that a toddler cannot disengage the fastening device without adult assistance.

Another object of this invention is to provide an access regulating apparatus, as aforesaid, that includes a locking assembly that must be released before the male/female fastening device can be accessed.

Still another object of this invention is to provide an access regulating apparatus, as aforesaid, wherein the locking assembly is a slider and pin combination.

Yet another object of this invention is to provide an access regulating apparatus, as aforesaid, wherein the locking assembly is a combination lock.

A further object of this invention is to provide an access regulating apparatus, as aforesaid, that may be utilized in between the male and female portions of a strap buckle type fastening device.

A still further object of this invention is to provide an access regulating apparatus, as aforesaid, that is easy for an adult to operate.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an access regulating apparatus according to one embodiment of the present invention, with a casing illustrated in an open configuration;

FIG. 2 is a perspective view of the access regulating apparatus with the casing illustrated in a closed configuration;

FIG. 3 is an end view of the access regulating apparatus as in FIG. 2 illustrating a lock passage in an unlocked configuration;

FIG. 4 is another end view of the access regulating apparatus as in FIG. 2 illustrating a lock passage in a locked configuration;

FIG. 5 is an exploded view of the access regulating apparatus as in FIG. 2;

FIG. 6 is a perspective view of an access regulating apparatus according to another embodiment of the present invention engaged with a male/female fastening device;

FIG. 7 is a perspective view of the access regulating apparatus as in FIG. 6 released from the male/female fastening device;

FIG. 8a is a top view of the access regulating apparatus as in FIG. 6;

FIG. 8b is a sectional view taken along line 8b-8b of FIG. 8a;

FIG. 9a is a top view of the access regulating apparatus as in FIG. 7;

FIG. 9b is a sectional view taken along line 9b-9b of FIG. 9a;

FIG. 10 is a perspective view of a combination lock fastening device according to another embodiment of the present invention illustrated in an engaged configuration;

FIG. 11 is a perspective view of the combination lock fastening device as in FIG. 10 illustrated in a disengaged configuration; and

FIG. 12 is an exploded view of the combination lock fastening device as in FIG. 11.

### DESCRIPTION OF THE PREFERRED EMBODIMENT

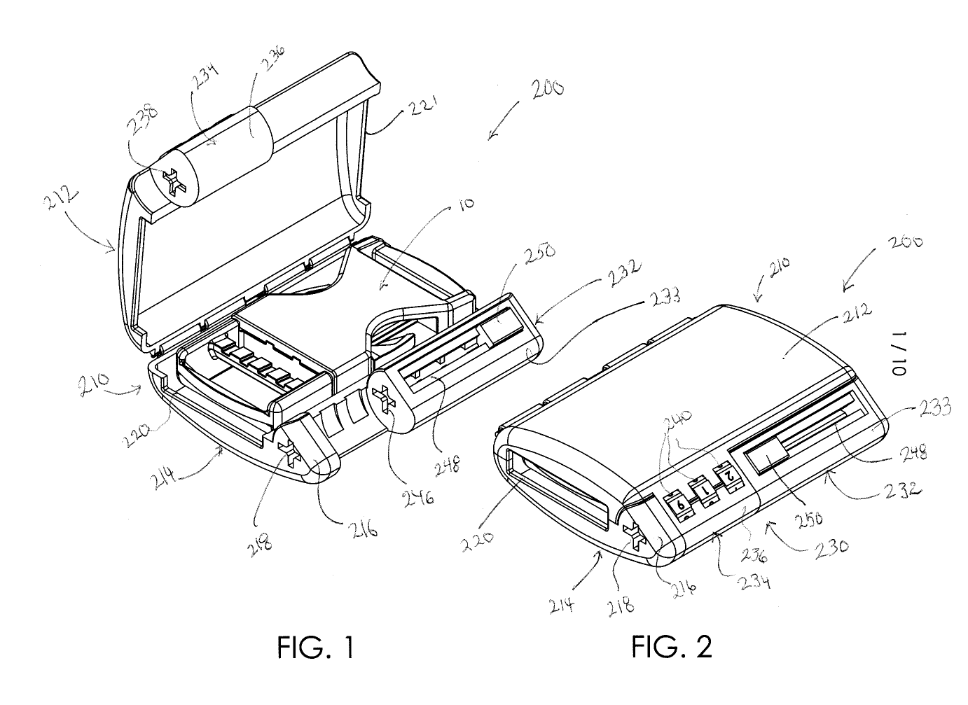

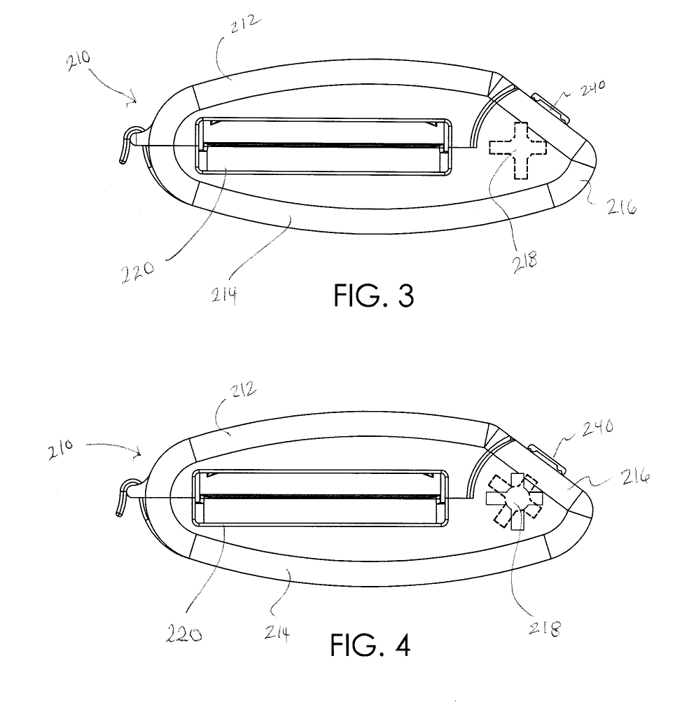

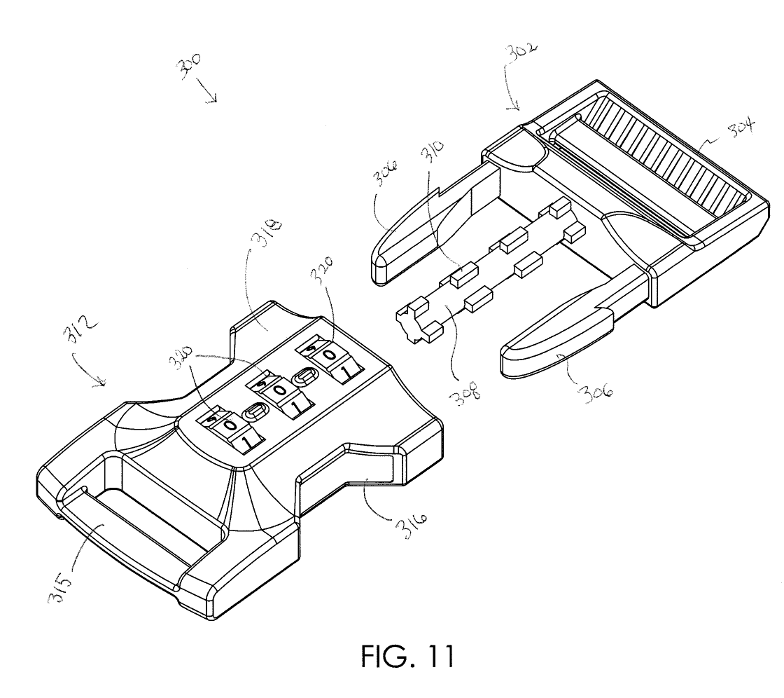

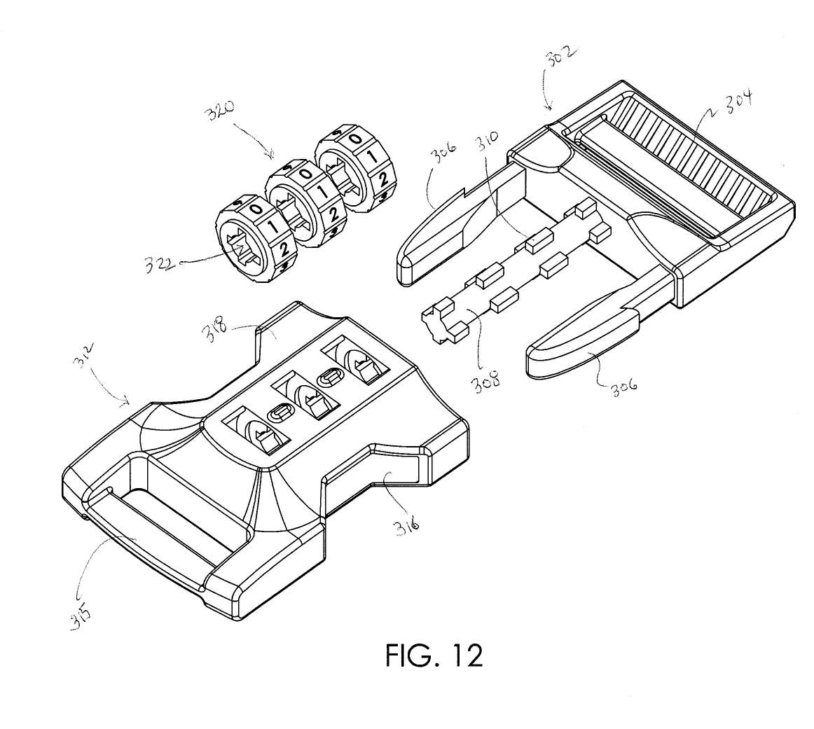

A buckle access regulating device according to a preferred embodiment of the present invention will now be described with reference to FIGS. 1 to 12 of the accompanying drawings. In one embodiment, the access regulating apparatus 10 includes a body member 110, a pair of retainer members 120, a slider assembly 130, and a stop 136 that regulates when the slider assembly 130 can be moved so as to give access to a strap type buckle fastening device.

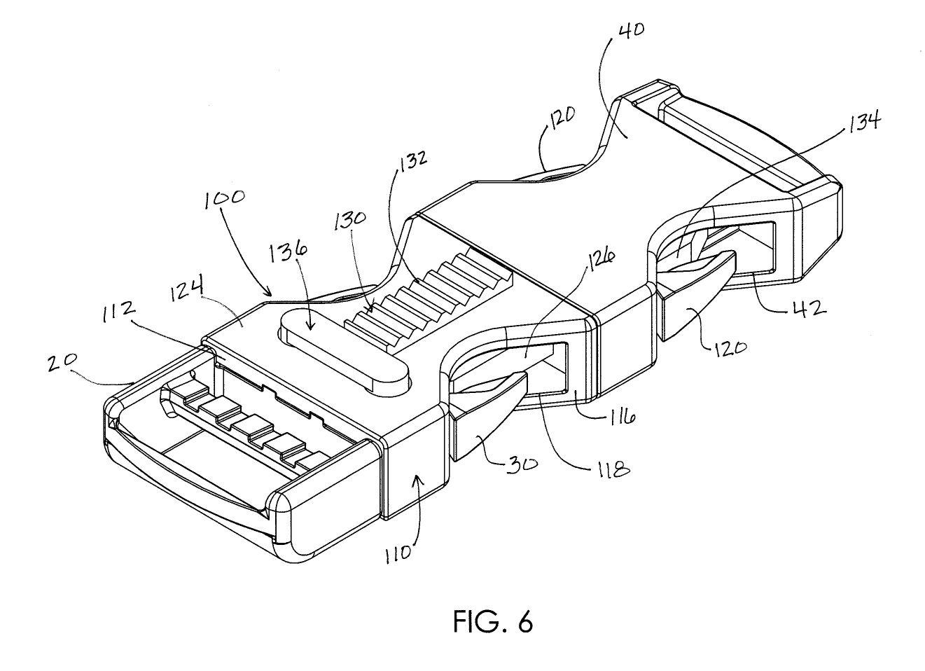

The access regulating apparatus 100 according to one embodiment is specifically configured for use with a traditional strap buckle fastening device (FIGS. 6 to 9b). The strap buckle fastening device includes a male retainer portion 20 and a female retainer portion 40. The male retainer portion 20 includes a pair of depressible retaining prongs 30 that are spaced apart, each one having a free end that is normally biased to protrude outwardly but can be depressed inwardly. Each retainer portion also includes an end secured to an end of a strap (not shown) or having a configuration to which a strap may be attached. The female retainer portion 40 of the traditional strap buckle fastening device 10 has a construction that defines an interior area configured to selectively receive the pair of retaining prongs 30. More particularly, the female retainer portion 40 may include side walls 116 that define slots 118 configured to engage the retaining prongs 30 when inserted into the interior area. Except as taught below with regard to the present invention, the retaining prongs 30 are normally disengaged from the slots 118 when depressed by the fingers of a person.

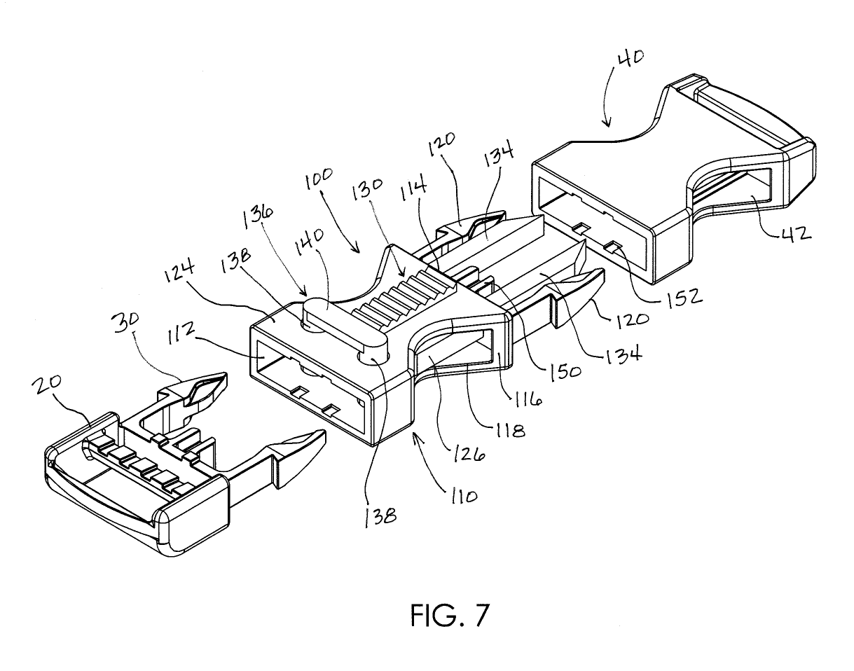

The access regulating apparatus 100 includes a body member 110 having walls that define an open rear end 112, an open front end 114, and defines an interior space that is configured to selectively retain the retaining prongs 30 of the male retainer portion 20 of a traditional fastening device in the manner described above. Specifically, the body member 110 includes side walls 116 that connect a bottom wall 122 with a top wall 124. Each side wall 116 defines a slot 118 that have a configuration complementary to that of a hook-shaped retainer prong 30 such that the prong 30 engages automatically because of its normally outward bias, the retaining prong 30 then being secured until it is disengaged as described previously (FIG. 7).

The access regulating apparatus 100 includes a pair of depressible retainer members 120 situated to extend forwardly through the open front end 114 of the body member 110 (FIG. 7). In use, the retainer members 120 may be received and secured by respective side wall slots 42 of the female retainer portion 40 of the traditional buckle fastening device 10 in the manner described above. The retainer members 120, however, can only be disengaged by operation of the novel structures to be described below.

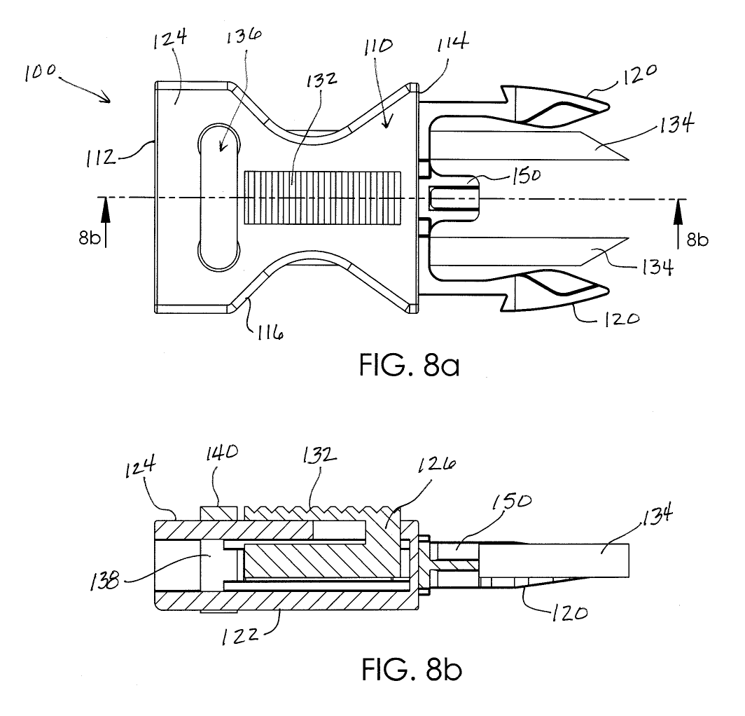

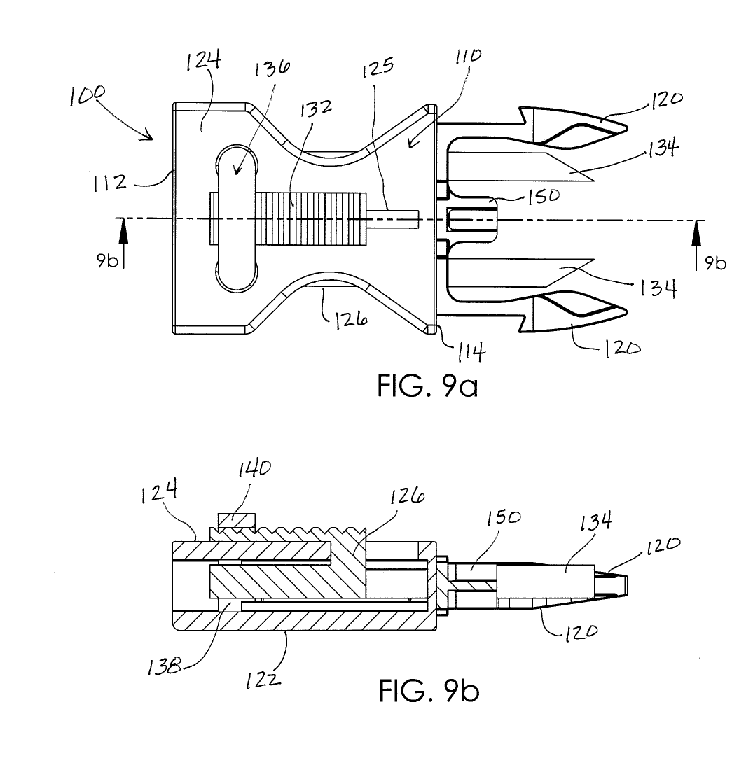

The access regulating apparatus 100 also includes a slider assembly 130. The slider assembly 130 includes an upper portion 132 slidably mounted to the body member 110. The upper portion 132 includes a pair of spaced apart locking members 134 operatively coupled to the upper portion 132 extending forwardly from the body member 110 through the open front 114 thereof (FIGS. 7, 8b, and 9b). The slider assembly 130 is movable between an extended configuration (FIG. 8a) at which the pair of locking members 134 are adjacent the retainer members 120, respectively, such that the retainer members 120 are prevented from being depressed and a retracted configuration (FIG. 9a) at which the locking members 134 are displaced from the retaining members 120 so as to allow depression of the retaining members 120 and disengagement of the retainer members 120. Preferably, the locking members 134 are constructed of a rigid material, such as a non-flexible plastic, so that any depression (e.g. squeezing) of the retainer members 120 is not allowed. The upper portion 132 may include a plurality of surface relief elements such as grooves, nubs, or the like, that enhance or improve a user's grip when attempting to slide the upper portion 132 along the channel 125.

The body member 110 includes a bottom wall 122 and an opposed top wall 124, the top wall defining a channel 125 extending substantially between the front end 114 and rear end 112 of the body member 110. The upper portion 132 of the slider assembly 130 includes first and second ends and has a generally linear shape and is positioned to slide on the top wall 124 of the body member 110 along the channel 125. Further, the slider assembly 130 includes a connection member 126, also referred to as a shaft, connecting a first end of the upper portion 132 to the pair of locking members 134 (FIG. 8b) such that the pair of locking members 134 move in parallel with movement of the upper portion 132. It is understood that the connection member 126 may also extend parallel to the upper portion 132 within the interior of the body member 110. Specifically, the pair of locking members 134 are parallel to the upper portion 132 of the slider assembly 130. Therefore, when the upper portion 132 is moved to the extended configuration, free ends of the locking members 134 are moved adjacent free ends of the retainer members so as to prevent them from being moved inwardly (FIG. 8a). In addition, the connection member 126 is positioned to block the retaining prongs 30 of the male retaining portion 20 from being disengaged when the upper portion 132 is at the retracted configuration.

By contrast, when the upper portion 132 is moved to the retracted configuration, the free ends of the locking members 134 are displaced from the free ends of the retainer members (FIGS. 9a and 9b). Further, the free ends of the locking members 134 may include an angled configuration so as to enable free ends of the retainer members 120 to extend inwardly when depressed. When the retainer members 120 are inwardly depressed, such as when squeezed by the fingers of a user, the retainer members 120 are released from the female retainer portion 40 of the buckle fastening device and the buckle is released. With the female retaining portion 40 released, the upper portion 132 may be move slightly toward the extended configuration such that the retaining prongs 30 may also be released from the access regulating apparatus 100.

The access regulating apparatus 100 further includes a stop 136 coupled to the body member 110 adjacent the rear end 112 thereof. The purpose of the stop 136 is to regulate when the slider assembly 130 is permitted to move from the extended configuration (preventing disengagement of the retainer members) to the retracted configuration (allowing disengagement of the retainer members). The stop 136 may be a pin, shaft, or other hardware that can be inserted through top wall 124 of the body member 110 and into the interior space, the stop 136 being is movable between a locked configuration preventing movement of the upper portion 132 of the slider assembly 130 and a released configuration allowing movement of the upper portion 132.

In the present embodiment, the stop 136 includes a pair of legs 138 that extend through the interior space and a bridge 140 connecting the pair of legs 138 and situated atop the top wall 124 of the body member 110. The bridge 140 is generally flush with the top wall 124 at the locked configuration (FIG. 8b) and prevents movement of the upper portion 132 of the slider assembly 130 and is upwardly/outwardly displaced from the top wall 124 at the released configuration (FIG. 9b) so as to allow the upper portion 132 to slide under or past the bridge 140.

An alignment flange 150 may be coupled to or integrally connected adjacent the open front end 114 of the body member 110. In some embodiments, the alignment flange 150 may be configured to mate with a corresponding alignment slot 152 defined by the female retainer portion 40 of the fastening device 10 (FIG. 7).

In use, the access regulating apparatus 100 may be positioned intermediate a male retainer portion 20 and a female retainer portion 40 of a traditional male/female buckle device. The retainer members 120 of the body member 110 may be inserted into the female retainer portion 40 and engaged with respective slots therein. The upper portion 120 of the slider assembly 130 may be moved to the extended configuration such that the retainer members 120 cannot be inwardly depressed or disengaged. If, at a later time, an adult desires to disengage the buckle fastening device 10, the stop 136 may be manually moved to the released configuration and the upper portion 120 of the slider assembly 130 may be slidably moved to the retracted configuration as described above (FIG. 9b). With the locking members 134 displaced from the retainer members 120, the retainer members 120 may be inwardly depressed and the body member 110 disengaged from the female retainer portion 40. Then, the upper portion 120 may be moved to the extended configuration such that the connection member 126 is displaced from the retaining prongs 30 of the male retaining portion 20 and the male retaining portion 20 may be removed from the access regulating apparatus 100. It is again noted that the structure and method described herein prevents a young child from disengaging a buckle fastening device due to the more sophisticated manipulations required by the present invention.

An access regulating apparatus 200 according to another embodiment is shown in FIGS. 1 to 5. In this embodiment, the access regulating apparatus 200 includes a casing 210 having an upper portion 212 pivotally coupled to a lower portion 214 along rear edges, respectively. Collectively, the upper and lower portions define an interior area configured to receive a buckle fastening device 10 therein. The upper portion 212 is pivotally movable between a closed configuration preventing access to the interior area (FIG. 2) and an open configuration allowing access to the interior area (FIG. 1). The casing 210 includes a first side that defines a first slot 220 that provides access to the interior area even when the upper and lower portions are closed. In like manner, the casing 210 includes a second side that defines a second slot 221 that provides access to the interior area even when the upper and lower portions are closed. It is understood that each slot may be partially defined by the lower portion 212 and partially defined by the upper portion 214 of the casing 210.

It is understood that the traditional buckle fastening device 10 includes a buckle secured to a strap (not shown). Specifically, a male retainer portion 20 is coupled to a first strap and the female retainer portion 40 is coupled to a second strap. The straps and retainer portions are useful for fastening a life jacket, fanny pack, back pack, or other products around a person's body. The side wall first slot 220 and second slot 221, therefore, enable respective straps to exit the casing 210 when the male retainer portion 20 and female retainer portion 40 are received in the interior area of the casing 210.

The access regulating apparatus 200 includes a combination lock assembly 230 configured to regulate when the casing 210 may be locked closed or may be opened. More particularly, the combination lock assembly 230 includes a first portion 232 mounted to the lower portion 214 of the casing 210 and a second portion 234 mounted to the upper portion 212 of the casing 210. The first and second portions are in adjacent alignment when the upper 212 and lower 214 portions of the casing 210 are at the closed configuration (FIG. 2) as will be described in more detail below.

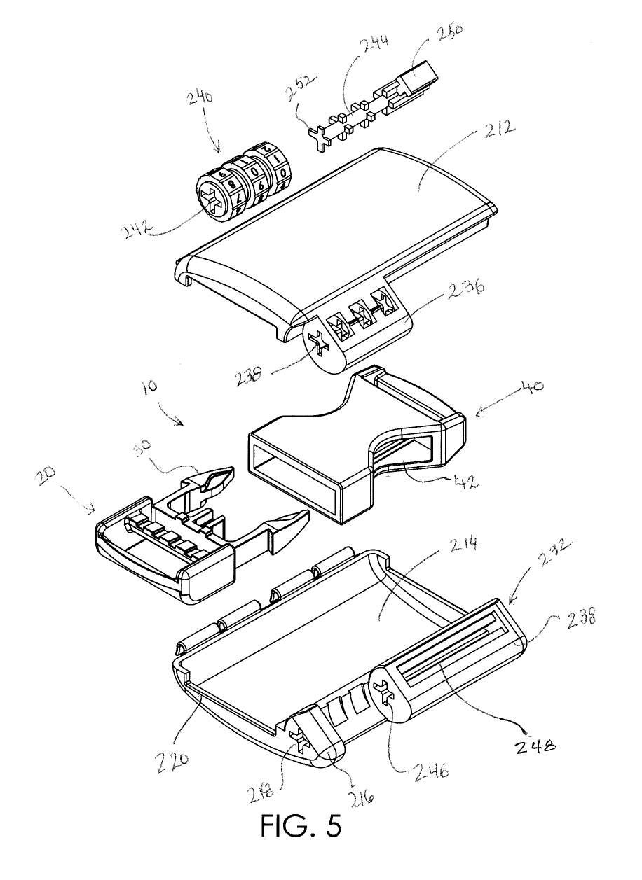

The first portion 232 of the combination lock assembly 230 includes a first portion housing 233 defining a hollow interior and a slot 248 in communication with the hollow interior. The first portion 232 of the combination lock assembly 230 includes a shaft 244 situated in the first portion housing 233 that is selectively movable between a retracted configuration substantially inside the first portion housing 233 and an extended configuration extending away from the first portion 232. The first portion housing 233 includes an end wall defining an aperture 246 (FIG. 5) through which the shaft 244 extends when moving to or from the extended configuration. The shaft 244 includes a slider tab 250 that extends upwardly/outwardly through the first portion housing slot 248 such that operation of the slider tab 250 by a person's finger causes the shaft 244 to move between the retracted and extended configurations.

With further reference to the combination lock assembly 230, the second portion 234 includes a plurality of numbered wheels 240 situated adjacent one another and define a lock passage 242 that allows movement of the shaft 244 when respective numbered wheels 240 are arranged at a predetermined unlocking configuration and that prevents movement of said shaft 244 when said respective numbered wheels 240 are arranged at a locking configuration.

The second portion 234 of the combination lock assembly 230 includes a second portion housing 236 having a hollow interior and that is configured to retain the plurality of numbered wheels 240 in a rotatable configuration. The second portion housing 236 defines a plurality of slots configured to receive a peripheral surface of respective wheels such that the respective wheels 240 may be turned by a person's finger. In addition, the second portion housing 236 includes a first end wall defining an opening 238 in communication with the lock passage 242 defined by the numbered wheels 240.

The second portion housing 236 is linearly adjacent the first portion housing 233 when the first portion of the casing 210 is at the closed configuration (FIG. 2). More particularly, the aperture 246 defined by the first portion housing 233 is linearly aligned with the opening 238 defined by the end wall of the second portion housing 236 when the upper portion 212 of the casing 210 is at the closed configuration such that the shaft 244 is selectively received into or out of the lock passage (defined by the numbered wheels) when the plurality of numbered wheels 240 are rotatably arranged at the unlocking configuration.

With reference to FIG. 1, the lower portion 214 of the casing 210 includes a locking flange 216 defining a lateral bore 218. In addition, the second portion housing 236 includes a second end wall defining a second opening (not shown) in communication with the lock passage. The bore 218 defined by the locking flange 216 is linearly aligned with the lock passage and with the aperture 246 defined by the first portion housing 233 when the upper portion 212 of the casing 210 is at the closed configuration (FIG. 2) such that a terminal end 252 of the shaft 244 is selectively retained in the bore 218 when the shaft 244 is at the extended configuration and the plurality of numbered wheels is at the unlocking configuration.

In use, the casing 210 may be moved to the open configuration (FIG. 1) and the male and female retainer portions of a strap buckle fastening device may be inserted into the interior area and the casing 210 closed again. The numbered wheels 240 may be rotatably positioned at a predetermined configuration (i.e. the combination lock code) and the slider tab 250 may be manipulated to urge the shaft 244 into the lock passage. Once inserted, the code may be mixed up such that the casing 210 cannot be opened. Presumably, this embodiment of the present invention is in use to prevent a toddler from gaining access to the buckle device 10 being stored in the casing 210. When desired, the numbered wheels may be rotated according to the predetermined code such that the shaft 244 may be released from the numbered wheels 240 as described above. Once released, the casing 210 may be moved to the open configuration (FIG. 1) and the buckle fastening device 10 removed from the casing 210 and disengaged.

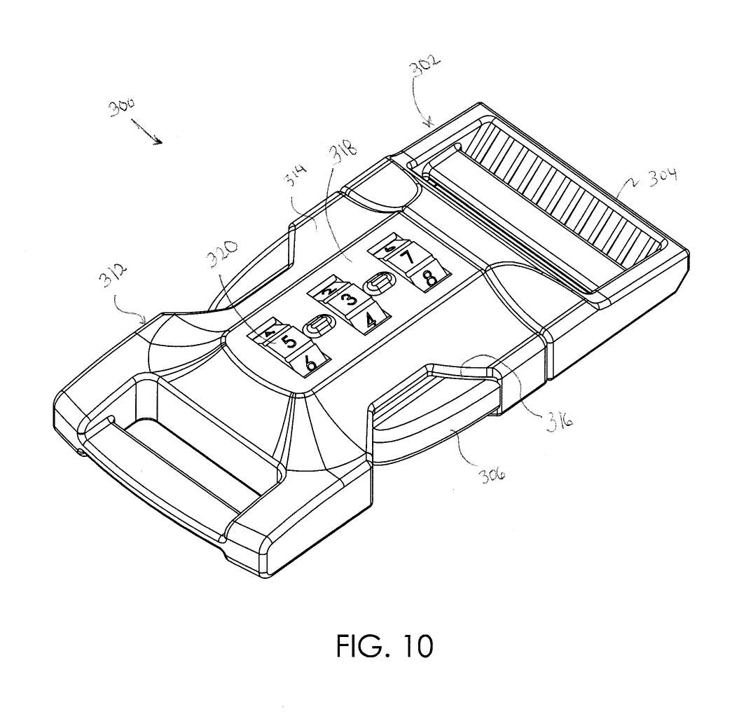

Another embodiment of the present invention is shown in FIGS. 10-12. In this embodiment, a combination lock fastening device 300 includes a male retaining member 302, a female retaining member 312, and a combination lock assembly. The male retaining member 302 includes a strap retaining buckle 304 that is secured to an end of a strap (not shown). A pair of depressible retaining members 306 is coupled to an inward end of the retaining buckle 304 and extends inwardly. Free ends of each retaining member 306 are biased to protrude outwardly in the manner described previously. The male retaining member 302 includes a lock shaft 308 coupled to the inward end of the retaining buckle intermediate the pair of retaining members 306 and extending inwardly away from the inward end.

The female retaining member 312 includes a housing 314 having a strap retaining buckle 315 and that defines an interior space. The housing 314 defines an interior space and has opposed side walls that define slots 316 configured to secure/engage respective retaining members 306 of the male retaining member 302. Each retaining member 306 is depressible so as to be disengaged from a respective retaining slot 316. Specifically, each retaining member 306 includes a free end having a generally hook-shaped configuration normally biased in an outwardly direction. Each side wall slot 316 of the female retaining member 312 is configured to receive and retain a respective retaining member 306 until the respective retaining member 306 is inwardly depressed.

The combination lock fastening device 10 includes a plurality of numbered wheels 320 rotatably mounted in the housing 314 of the female retaining member 312 adjacent one another and defining a lock passage 322 therethrough that is configured to receive the lock shaft 308 when respective numbered wheels 320 are rotatably positioned at a predetermined unlocking configuration. Conversely, the lock passage does not allow movement of the lock shaft 308 when respective numbered wheels are rotatably arranged at a locking configuration. The lock shaft 308 and lock passage are positioned in linear alignment.

The female retaining member 312 includes a top wall 124 defining a plurality of slots each being configured to receive a peripheral surface of respective numbered wheels 320 so as to be turned by a person's finger and, as a result, set to a predetermined unlocking configuration.

Preferably, the lock shaft 308 may include a plurality of spaced apart nubs 310. Correspondingly, an internal radial surface of each of the plurality of numbered wheels 320 defines a plurality of radially spaced recesses corresponding to the plurality of nubs 310. In use, the nubs 310 form a friction fit engagement with the internal radial surface so as to prevent movement of the lock shaft 308 until a predetermined combination of respective nubs 310 and recesses are aligned.

In use, the plurality of numbered wheels 320 must be rotatably positioned in a predetermined arrangement before the lock passage will either receive or release the lock shaft 308. When received, the male retaining member 302 may not be disengaged from the female retaining member 312. But when released, the male retaining member 302 may be disengaged from the female retaining member 312.

It is understood that while certain forms of this invention have been illustrated and described, it is not limited thereto except insofar as such limitations are included in the following claims and allowable functional equivalents thereof.

1. An access regulating apparatus for use with a fastening device that includes a male retainer portion coupled to a first strap and having a pair of selectively depressible retaining prongs and that includes a female retainer portion coupled to a second strap and defining an interior area configured to selectively receive said pair of retaining prongs, said access regulating device, comprising:
a casing having a lower portion and an upper portion pivotally coupled to said lower portion so as to define an interior area, said upper portion being movable between a closed configuration preventing access to said interior area and an open configuration allowing access to said interior area;
a combination lock assembly having a first portion mounted to said lower portion of said casing and a second portion mounted to said upper portion of said casing, said first and second portions of said combination lock assembly being situated in linear alignment when said upper portion of said casing is at said closed configuration;
wherein said first portion includes a shaft that is selectively movable between a retracted configuration substantially inside said first portion and an extended configuration extending away from said first portion; and
wherein said second portion includes a plurality of numbered wheels situated adjacent one another and defining a lock passage that allows movement of said shaft when respective numbered wheels are arranged at a predetermined unlocking configuration and that prevents movement of said shaft when said respective numbered wheels are arranged at a locking configuration.

2. The access regulating apparatus as in claim 1, wherein:
said first portion of said combination lock assembly includes a first portion housing that defines a hollow interior and a slot in communication with said hollow interior;
said first portion housing includes an end wall defining an aperture through which said shaft is selectively extended; and
said shaft is situated in said hollow interior and includes a slider tab extending outwardly through said slot such that operation of said slider tab causes said shaft to move between said retracted and said extended configurations.

3. The access regulating apparatus as in claim 2, wherein:
said second portion of said combination lock assembly includes a second portion housing defining a hollow interior configured to rotatably retain said plurality of numbered wheels, said second portion housing defining a plurality of slots configured to receive a peripheral surface of respective numbered wheels so as to be turned by a user's finger; and
said second portion housing includes a first end wall defining an opening in communication with said lock passage.

4. The access regulating apparatus as in claim 3, wherein:
said second portion housing is linearly adjacent said first portion housing when said first portion of said casing is at said closed configuration; and
said aperture in said end wall of said first portion housing is linearly aligned with said opening of said end wall of said second portion housing when said first portion of said casing is at said closed configuration such that said shaft is selectively received into or out of said lock passage when said plurality of numbered wheels are configured at said unlocking configuration.

5. The access regulating apparatus as in claim 1, wherein:
said interior area is configured to selectively receive the fastening device;
said casing defines a first slot configured to receive the first strap when the male retainer portion of the fastening device is situated in said interior area; and
said casing defines a second slot configured to receive the second strap when the female retainer portion of the fastening device is situated in said interior area.

6. The access regulating apparatus as in claim 4, wherein:
said lower portion of said casing includes a locking flange defining a bore;
said second portion housing includes a second end wall defining a second opening in communication with said lock passage; and
said bore of said locking flange is linearly aligned with said lock passage and with said aperture of said first portion housing when said upper portion of said casing is at said closed configuration, such that a terminal end of said shaft is selectively retained in said bore when said shaft is at said extended configuration and said plurality of numbered wheels is at said unlocking configuration.

7. An access regulating apparatus for use with a fastening device that includes a male retainer portion coupled to a first strap and having a pair of selectively depressible retaining prongs and that includes a female retainer portion coupled to a second strap and defining an interior area configured to selectively receive said pair of retaining prongs, said access regulating device, comprising:
a casing having a lower portion and an upper portion pivotally coupled to said lower portion so as to define an interior area, said upper portion being movable between a closed configuration preventing access to said interior area and an open configuration allowing access to said interior area;
a combination lock assembly having a first portion mounted to said lower portion of said casing and a second portion mounted to said upper portion of said casing;
wherein said first portion includes a shaft that is selectively movable between a retracted configuration substantially inside said first portion and an extended configuration extending away from said first portion;
wherein said second portion includes a plurality of numbered wheels situated adjacent one another and defining a lock passage that allows movement of said shaft when respective numbered wheels are arranged at a predetermined unlocking configuration and that prevents movement of said shaft when said respective numbered wheels are arranged at a locking configuration.

8. The access regulating apparatus as in claim 7, wherein:
said first and second portions of said combination lock assembly are situated in linear alignment when said upper portion of said casing is at said closed configuration;
said first portion of said combination lock assembly includes a first portion housing that defines a hollow interior and a slot in communication with said hollow interior;
said first portion housing includes an end wall defining an aperture through which said shaft is selectively extended; and
said shaft is situated in said hollow interior and includes a slider tab extending outwardly through said slot such that operation of said slider tab causes said shaft to move between said retracted and said extended configurations.

9. The access regulating apparatus as in claim 9, wherein:
said second portion of said combination lock assembly includes a second portion housing defining a hollow interior configured to rotatably retain said plurality of numbered wheels, said second portion housing defining a plurality of slots configured to receive a peripheral surface of respective numbered wheels so as to be turned by a user's finger; and
said second portion housing includes a first end wall defining an opening in communication with said lock passage.

10. The access regulating apparatus as in claim 9, wherein:
said second portion housing is linearly adjacent said first portion housing when said first portion of said casing is at said closed configuration; and
said aperture in said end wall of said first portion housing is linearly aligned with said opening of said end wall of said second portion housing when said first portion of said casing is at said closed configuration such that said shaft is selectively received into or out of said lock passage when said plurality of numbered wheels are configured at said unlocking configuration.

11. The access regulating apparatus as in claim 7, wherein:
said interior area is configured to selectively receive the fastening device;
said casing defines a first slot configured to receive the first strap when the male retainer portion of the fastening device is situated in said interior area; and
said casing defines a second slot configured to receive the second strap when the female retainer portion of the fastening device is situated in said interior area.

12. The access regulating apparatus as in claim 10, wherein:
said lower portion of said casing includes a locking flange defining a bore;
said second portion housing includes a second end wall defining a second opening in communication with said lock passage; and
said bore of said locking flange is linearly aligned with said lock passage and with said aperture of said first portion housing when said upper portion of said casing is at said closed configuration, such that a terminal end of said shaft is selectively retained in said bore when said shaft is at said extended configuration and said plurality of numbered wheels is at said unlocking configuration.

13. A combination lock fastening device, comprising:
a male retaining member having a strap retaining buckle and a pair of selectively depressible retaining members coupled to an inward end of said retaining buckle and extending inwardly;
wherein said male retaining member includes a lock shaft coupled to said inward end of said retaining buckle intermediate said pair of retaining members and extending inwardly from said inward end;
wherein each retaining member is biased to protrude outwardly;
a female retaining member having a housing having a strap retaining buckle and that defines an interior space and that defines a pair of opposed retaining slots configured to selectively engage said pair of retaining members, respectively, said pair of retaining members being depressible so as to disengage said retaining slots;
a plurality of numbered wheels rotatably mounted in said housing of said female retaining member situated adjacent one another and defining a lock passage configured to receive or release said lock shaft when respective numbered wheels are arranged at a predetermined unlocking configuration and configured to prevent movement of said lock shaft when said respective numbered wheels are arranged at a locking configuration.

14. The combination lock fastening device as in claim 13, wherein:
each retaining member includes a free end having a generally hook shaped configuration; and
said female retaining member includes opposed side walls defining said retaining slots, each retaining slot being configured to receive and retain a respective retaining member until said received retaining member is inwardly depressed.

15. The combination lock fastening device as in claim 13, wherein said female retaining member includes a top wall defining a plurality of slots each being configured to receive a peripheral surface of respective numbered wheels so as to be turned by a user's finger.

16. The combination lock fastening device as in claim 13, wherein:
said lock shaft includes a plurality of spaced apart nubs;
each of said plurality of numbered wheels defines a plurality of recesses corresponding to said plurality of nubs; and
said nubs form a friction fit engagement with an internal peripheral surface of respective numbered wheels so as to prevent movement of said lock shaft until a predetermined combination of respective nubs and respective recesses are aligned.

17. The combination lock fastening device as in claim 13, wherein said lock shaft and said lock passage are in linear alignment.
